(19) United States
(12) Patent Application Publication
(10) Pub. No.: US 2003/0187734 A1
(43) Pub. Date: Oct. 2, 2003

(54) Idea market

(76) Inventor: David Andrew Pearson, Huntington Beach, CA (US)

Correspondence Address: DAVID PEARSON, 22102 CAPE MAY LANE, HUNTINGTON BEACH, CA, 92646, US

(21) Appl. No.: 10/113,482

(22) Filed: Apr. 2, 2002

(51) Int. Cl. G06F 17/60

(52) U.S. Cl. 705/14

(57) ABSTRACT

The advertisment of inventions as a means to protect, access value and attempt to market them. The inventions would be described and a percentage of ownership would be offered in the advertisments. The inventor would be identified and a copy of the advertisment can be retained by the inventor for protection.

### FIELD

### Advertising

The invention relates to the marketing of inventions

### PRIOR ART

Currently, the method for marketing, protecting and accessing value of inventions described here-in is not present in the prior art.

### BRIEF SUMMARY

The object of this invention is to use advertising to protect and access value of inventions and the like. The inventions would be described to the public by advertising as a means for protection. The advertised descriptions would be an (inexpensive) way to protect and access value of the inventions. The advertisments would access value and (attempt to) market the inventions by offering a percentage of them for sale to the public. Copies (or other proof) of the advertisments can be retained by the inventors to use as proof that they are, in fact, the inventors of the inventions.

This invention is a marketing stragety aimed at eliminating the need for patents. It is expected that it can make them obsolete and take thier place.

It is anticipated that it can also function as a way to pay for the expenses of obtaining a patent for successful inventions: Small percentages of said inventions can be sold and the revenue can be used to pay for fees, lawyers (and other such expenses). Further, It is anticipated that it can be used to to determine whether a patent on an invention is worth pursueing: If unable to sell percentages, it can be assumed that is not worth it.

The conception can be used for types of ideas for which patents/trademarks are not normally pursued. The inventions mentioned here-in can be ideas for patents or trademarks.

It is expected that the sales of percentages can be done by mail. It is anticipated that contracts can be used. Said contracts can be subject to change. It is a suggestion that they can stipulate that they are not valid unless proof of payment, for example, returned checks or reciepts from the inventors (behalf) are attached to (copies of) the contracts. It is also suggested that the contracts can be altered if unsatisfactory to the buyer.

### BRIEF DESCRIPTION OF THE DRAWING

FIG. 1 is a front view.

### DETAILED DESCRIPTIONS OF THE DRAWING

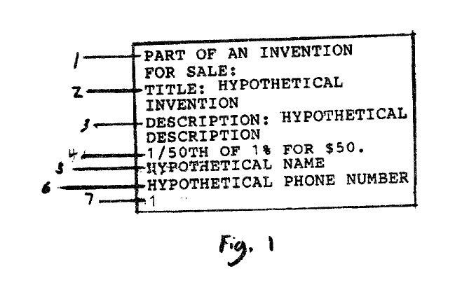

FIG. 1 illustrates an example of an advertisment. The advertisment is subject to change. It is suggested that it can be altered if it is determined that it is unsatisfactory. The embodiment of this example is an ad in a newspaper classified section. The embodiment is subject to change.

1. Advertisment identifier can be a description of what is advertised. Information about ideas that are filed with the USPTO can be included.

2. Title can be a name for the invention.

3. Description can be a description of the invention. Enough detail can be used to adequately explain the invention to the readers so that they would understand it. Information about registration with the USPTO (patent numbers and the like) can be included.

4. Offer can be an offer for legal ownership of one or more percentages of the described invention for a price. The offer can be for one or more shares at a predetermined percentage rate. Percentage rate can be subject to change. Amount of percentage can be subject to change. One hundred percent can be offered. Percentage rate can vary with quantity of percentage purchased. Percentage rate can be described in dollars per percent or percentage.

5. Identifier can be the name of the inventor. Full names and initials can be used. Identifiers other than names can be used. It can be used to identify the inventor.

6. Phone number can be a phone number. It can be the phone number of the inventors. It can be used to further identify the inventor.

7. Invention number can be a (legal) number assigned to the invention. It can have the same effect as a patent number. Numbers assigned by the USPTO (patent numbers/filing application numbers) can (also be used. Information about trademark registration can be included.

(Dedicated) sections for idea marketing for advertisers (newspapers and the like and advertisers on the internet) is expected. It is also expected that the internet and (dedicated) advertising publications (that are distributed by mail) such as the pennysaver, can be used to market ideas. It is expected that internet addresses can be used to (further) identify the inventors.

The possibility of a means for producing and distributing signs [for vehicles that are for the purpose of advertising items (other than or along with the vehicles) that are for sale sale] and flyers (both of which for the purpose of marketing ideas is predicted. The possibility of a means to distribute the flyers by mail, (dedicated) publications idea marketing, air wave, satillite and cable media (t.v./radio), bus stop bench signs and telemarketing as a means to market ideas, and the marketing of ideas at stores, banks and the like and the use of vending machines to market ideas is also predicted.

1. A marketing method in which inventions are advertised and described to the public. Ownership of percentages of the inventions is offered. The inventor is identified by the advertisment. A copy of the item that contains the advertisment can be retained by the inventor to protect the invention. This method can also be used to market and access value of the inventions.
